(19) United States
(12) Patent Application Publication
(10) Pub. No.: US 2026/0135597 A1
(43) Pub. Date: May 14, 2026

(54) TWO STAGE CHANNEL STATE INFORMATION REPORTING

(71) Applicant: QUALCOMM Incorporated, San Diego, CA (US)

(72) Inventors: Doohyun SUNG, Basking Ridge, NJ (US); Wooseok NAM, San Diego, CA (US); Tao LUO, San Diego, CA (US)

(21) Appl. No.: 19/316,726

(22) Filed: Sep. 2, 2025

Related U.S. Application Data
(60) Provisional application No. 63/718,462, filed on Nov. 8, 2024.

(51) Int. Cl. H04B 7/06; H04L 5/00

(52) U.S. Cl. CPC H04B 7/0626; H04L 5/0048

(57) ABSTRACT

Methods, systems, and devices for wireless communications are described. The described techniques provide for a user equipment (UE) to perform two-stage channel state information (CSI) reporting for candidate cells as part of a handover. The UE may transmit a stage 1 CSI report that indicates coarse channel status information for the candidate cells. The stage 1 CSI report may include one or more unit stage 1 CSI reports that each include respective pairs of information associated with a candidate cell and a CSI resource. The UE may transmit, after the stage 1 CSI report, a stage 2 CSI report that indicates fine channel status information for the candidate cells. The stage 2 CSI report may include one or more stage 2 unit CSI reports including the respective pairs of information associated with candidate cells and CSI resources.

### CROSS-REFERENCE

The present application for patent claims priority to U.S. Provisional Patent Application No. 63/718,462 by Sung et al., entitled “TWO STAGE CHANNEL STATE INFORMATION REPORTING,” filed Nov. 8, 2024, which is assigned to the assignee hereof, and is expressly incorporated by reference herein.

### TECHNICAL FIELD

The following relates to wireless communications, including two stage channel state information reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may perform a handover procedure to swap connections between serving cells, for example to switch from connecting to a first serving cell to connecting to a second serving cell, which may provide an improved connection for the UE.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more reference signals that are associated with one or more candidate cells, transmitting, to a network entity, a first stage channel state information (CSI) report based on the one or more reference signals, where the first stage CSI report includes a first format for indicating one or more first unit CSI reports associated with the one or more candidate cells and one or more CSI resources, and transmitting, after transmission of the first stage CSI report, a second stage CSI report based on the first stage CSI report, where the second stage CSI report includes a second format for indicating one or more second unit CSI reports associated with the one or more candidate cells and the one or more CSI resources, the second format different from the first format.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive one or more reference signals that are associated with one or more candidate cells, transmit, to a network entity, a first stage CSI report based on the one or more reference signals, where the first stage CSI report includes a first format for indicating one or more first unit CSI reports associated with the one or more candidate cells and one or more CSI resources, and transmit, after transmission of the first stage CSI report, a second stage CSI report based on the first stage CSI report, where the second stage CSI report includes a second format for indicating one or more second unit CSI reports associated with the one or more candidate cells and the one or more CSI resources, the second format different from the first format.

Another UE for wireless communications is described. The UE may include means for receiving one or more reference signals that are associated with one or more candidate cells, means for transmitting, to a network entity, a first stage CSI report based on the one or more reference signals, where the first stage CSI report includes a first format for indicating one or more first unit CSI reports associated with the one or more candidate cells and one or more CSI resources, and means for transmitting, after transmission of the first stage CSI report, a second stage CSI report based on the first stage CSI report, where the second stage CSI report includes a second format for indicating one or more second unit CSI reports associated with the one or more candidate cells and the one or more CSI resources, the second format different from the first format.

A non-transitory computer-readable medium storing code for wireless communications is described. The code may include instructions executable by one or more processors (e.g., directly, indirectly, after pre-processing, without pre-processing) to receive one or more reference signals that are associated with one or more candidate cells, transmit, to a network entity, a first stage CSI report based on the one or more reference signals, where the first stage CSI report includes a first format for indicating one or more first unit CSI reports associated with the one or more candidate cells and one or more CSI resources, and transmit, after transmission of the first stage CSI report, a second stage CSI report based on the first stage CSI report, where the second stage CSI report includes a second format for indicating one or more second unit CSI reports associated with the one or more candidate cells and the one or more CSI resources, the second format different from the first format.

Some examples of the method, UEs, and non-transitory computer-readable medium described herein may further include operations, features, means, or instructions for generating the one or more first unit CSI reports based on measurements of the one or more reference signals and aggregating the one or more first unit CSI reports to obtain the first stage CSI report, where transmitting the first stage CSI report may be based on obtaining the first stage CSI report.

In some examples of the method, UEs, and non-transitory computer-readable medium described herein, generating the one or more first unit CSI reports may include operations, features, means, or instructions for generating at least two first unit CSI reports of the one or more first unit CSI reports using an integer quantity of CSI processing units of the UE.

In some examples of the method, UEs, and non-transitory computer-readable medium described herein, each unit CSI report of the one or more first unit CSI reports indicates CSI for respective pairs of information each including a candidate cell and a CSI resource.

Some examples of the method, UEs, and non-transitory computer-readable medium described herein may further include operations, features, means, or instructions for receiving, from the network entity, a message indicating a list of respective pairs of information each including a candidate cell and a CSI resource to be included in the first stage CSI report, where the first stage CSI report includes the one or more first unit CSI reports based on receiving the message.

Some examples of the method, UEs, and non-transitory computer-readable medium described herein may further include operations, features, means, or instructions for obtaining a first CSI measurement associated with a first pair of the list of respective pairs, where the first stage CSI report excludes CSI associated with the first pair based on the first CSI measurement.

In some examples of the method, UEs, and non-transitory computer-readable medium described herein, the first format may be associated with reporting a wideband precoding matrix indicator (PMI) and a rank indicator for each of the one or more first unit CSI reports.

In some examples of the method, UEs, and non-transitory computer-readable medium described herein, the first format may be associated with reporting a rank indicator and a channel quality indicator (CQI) for each of the one or more first unit CSI reports.

In some examples of the method, UEs, and non-transitory computer-readable medium described herein, the first format may be associated with reporting a first part of a two-part CSI associated with each of the one or more first unit CSI reports.

Some examples of the method, UEs, and non-transitory computer-readable medium described herein may further include operations, features, means, or instructions for quantizing one or more CSI parameters for each of the one or more first unit CSI reports, where the first format may be associated with reporting the quantized one or more CSI parameters.

In some examples of the method, UEs, and non-transitory computer-readable medium described herein, the first format may be associated with reporting first CSI for each of the one or more first unit CSI reports and the second format may be associated with reporting a difference for one or more parameters relative to the corresponding ones of the first CSI.

In some examples of the method, UEs, and non-transitory computer-readable medium described herein, the first stage CSI report may be transmitted via an uplink control information (UCI) message or via a media access control-control element (MAC-CE), or any combination thereof.

In some examples of the method, UEs, and non-transitory computer-readable medium described herein, each unit CSI report of the one or more second unit CSI reports indicates CSI for respective pairs of information each including a candidate cell and a CSI resource.

Some examples of the method, UEs, and non-transitory computer-readable medium described herein may further include operations, features, means, or instructions for receiving control information including a first configuration of the first stage CSI report, where the first configuration includes an indication to transmit the first stage CSI report according to a first periodicity, semi-persistently, in response to reception of a first trigger, in response to an occurrence of one or more events, or any combination thereof.

In some examples of the method, UEs, and non-transitory computer-readable medium described herein, the control information further includes a second configuration of the second stage CSI report and one or more parameters of the second configuration may be the same as one or more parameters of the first configuration.

In some examples of the method, UEs, and non-transitory computer-readable medium described herein, the one or more second unit CSI reports include one or more report quantities that may be omitted from corresponding ones of the one or more first unit CSI reports; the second stage CSI report may be transmitted aperiodically or in accordance with a periodicity, and the first configuration or the second configuration, or both, indicates one or more time offset values between the first stage CSI report and the second stage CSI report.

In some examples of the method, UEs, and non-transitory computer-readable medium described herein, the control information further includes a second configuration of the second stage CSI report and one or more parameters of the second configuration may be different from one or more parameters of the first configuration.

In some examples of the method, UEs, and non-transitory computer-readable medium described herein, the one or more parameters of the second configuration include a first reporting type that may be different from a second reporting type indicated by the one or more parameters of the first configuration.

In some examples of the method, UEs, and non-transitory computer-readable medium described herein, the second format may be associated with reporting a sub-band PMI and a CQI for each of the one or more second unit CSI reports.

In some examples of the method, UEs, and non-transitory computer-readable medium described herein, the second format may be associated with reporting a sub-band PMI, a wideband PMI, or a CQI, or any combination thereof, for each of the one or more second unit CSI reports.

In some examples of the method, UEs, and non-transitory computer-readable medium described herein, the second format may be associated with reporting a second part of a two-part CSI associated with each of the one or more second unit CSI reports.

In some examples of the method, UEs, and non-transitory computer-readable medium described herein, the second stage CSI report may be transmitted via a UCI message or via a MAC-CE, or any combination thereof.

In some examples of the method, UEs, and non-transitory computer-readable medium described herein, transmitting the second stage CSI report may include operations, features, means, or instructions for transmitting the second stage CSI report to the network entity, to another network entity, or both.

In some examples of the method, UEs, and non-transitory computer-readable medium described herein, the first format may be associated with a first resolution of CSI and the second format may be associated with a second resolution of the CSI, the second resolution being greater than the first resolution.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports two stage channel state information (CSI) reporting in accordance with one or more aspects of the present disclosure.

FIG. 2 shows an example of a wireless communications system that supports two stage CSI reporting in accordance with one or more aspects of the present disclosure.

FIG. 3 shows an example of a process flow that supports two stage CSI reporting in accordance with one or more aspects of the present disclosure.

FIGS. 4 and 5 show block diagrams of devices that support two stage CSI reporting in accordance with one or more aspects of the present disclosure.

FIG. 6 shows a block diagram of a communications manager that supports two stage CSI reporting in accordance with one or more aspects of the present disclosure.

FIG. 7 shows a diagram of a system including a device that supports two stage CSI reporting in accordance with one or more aspects of the present disclosure.

FIG. 8 shows a flowchart illustrating methods that support two stage CSI reporting in accordance with one or more aspects of the present disclosure.

### DETAILED DESCRIPTION

In some wireless communications systems, a user equipment (UE) may perform a handover procedure to switch connections between one or more serving cells (e.g., associated with one or more network entities). For example, the UE may communicate with a first serving cell that the UE previously established a connection with and may determine to switch connections to a different cell, such as a candidate target cell (e.g., due to identifying an improvement in the connection with the different cell relative to the first serving cell). A candidate cell may be an example of a cell that does not currently serve the UE, but is capable and/or available to serve the UE for subsequent operations and signaling (e.g., a candidate target cell, a neighboring cell to a cell currently serving the UE). In some cases, the handover procedure may be initiated by the UE, for example, via a lower-layer triggered mobility (LTM) cell switch procedure. As part of communicating with the first serving cell, the UE may report information, such as information related to one or more beams used by the UE for communications, to the first serving cell in a channel state information (CSI) report. Additionally, to support the cell switch, the UE may measure and report information associated with one or more candidate cells available for the UE to switch to (e.g., acquiring CSI for the one or more candidate cells). However, acquiring the CSI for the candidate cells may incur significant overhead, for example, due to performing measurements for a relatively large quantity of candidate cells and corresponding transmission configuration indicator (TCI) states. Further, CSI information for the candidate cells may become outdated while the UE performs the cell switch procedure, which may adversely impact the connection between the UE and a new serving cell (e.g., due to changing channel conditions).

Techniques described herein provide for a UE to perform two-stage CSI reporting for candidate cells as part of a cell switch procedure, which may mitigate measurement and/or reporting overhead, as well as enable a candidate target cell (e.g., a neighboring cell) to obtain a CSI update with reduced latency relative to when the cell switch was executed. For example, the UE may measure CSI reference signals from candidate cells and may transmit a first stage of a CSI report (e.g., a stage 1 CSI report) to a current serving cell, where the first stage of the CSI report may indicate relatively coarse channel status information (e.g., information capturing a relatively large scale channels status and/or low-resolution channel status, such as a wideband channel status) for the candidate cells. The first stage of the CSI report may have a first format for indicating one or more unit CSI reports (e.g., a final stage 1 CSI report may include one or multiple unit stage 1 CSI reports that are aggregated) that each include respective pairs of information (e.g., measurement information) associated with a candidate cell and a CSI resource. In some cases, a payload of each unit stage 1 CSI report may be reduced (e.g., relative to a conventional CSI report), for example by including a subset of CSI parameters, including only CSI part 1, or quantizing CSI parameters, which may reduce overhead associated with indicating the stage 1 CSI report.

The UE may transmit, after the first stage of the CSI report, a second stage of the CSI report (e.g., a stage 2 CSI report) that indicates relatively fine channel status information (e.g., information capturing relatively small scale and/or detailed channel status, such as sub-band channel status and/or channel variations relative to the stage 1 CSI report) for the candidate cells. For example, the second stage of the CSI report may have a second format (e.g., different from the first format of the stage 1 CSI report, for example including fine channel status information relative to the stage 1 CSI report) for indicating one or more unit CSI reports (e.g., unit stage CSI reports) including the respective pairs of information associated with candidate cells and CSI resources. Such techniques may enable candidate cells to acquire CSI information as-needed, for example obtaining the fine channel status information shortly before or after a cell switch, (e.g., to ensure or otherwise support an improved connection between the UE and a new serving cell relative to a previous serving cell).

Aspects of the disclosure are initially described in the context of wireless communications systems and a process flow. Aspects of the disclosure are further illustrated by and described with reference to apparatus diagrams, system diagrams, and flowcharts that relate to two stage CSI reporting.

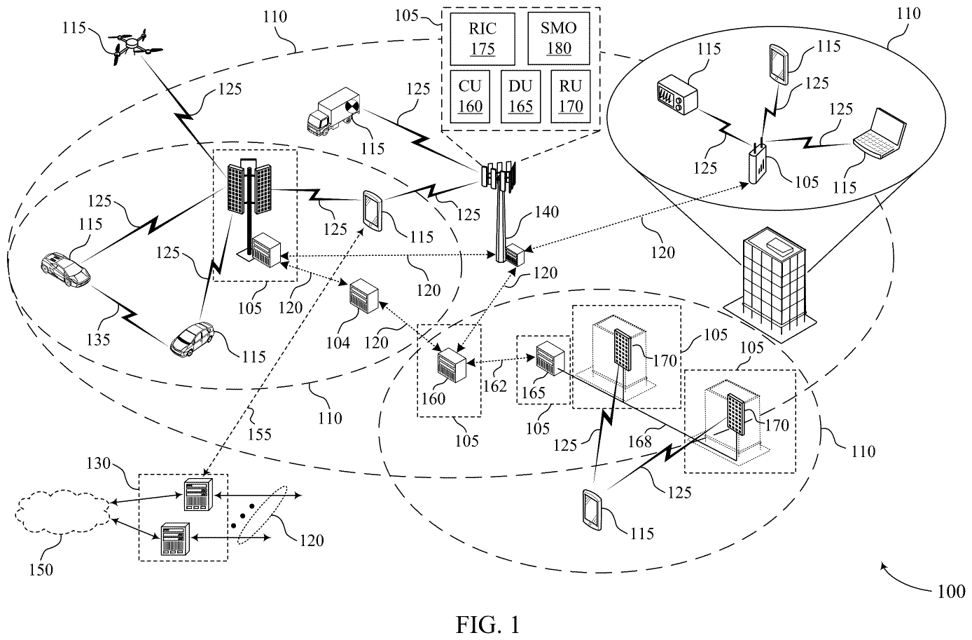

FIG. 1 shows an example of a wireless communications system 100 that supports two stage CSI reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support two stage CSI reporting as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A quasi co-location (QCL) relationship between one or more transmissions or signals may refer to a relationship between the antenna ports (and the corresponding signaling beams) of the respective transmissions. For example, one or more antenna ports may be implemented by a network entity 105 for transmitting at least one or more reference signals (such as a downlink reference signal, a synchronization signal block (SSB), or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being quasi co-located (QCLed). QCLed signals may enable the UE 115 to derive the properties of a first signal (e.g., delay spread, Doppler spread, frequency shift, average power) transmitted via a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as CSI-RS) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relationship between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relationship between two or more directional beams used to communicate signals. Here, the spatial parameters may indicate that a first beam used to transmit a first signal may be similar (or the same) as another beam used to transmit a second, different, signal, or, that the same receive beam may be used to receive both the first and the second signal. Thus, the beam information for various beams may be derived through receiving signals from a transmitting device, where, in some cases, the QCL information or spatial information may help a receiving device efficient identify communications beams (e.g., without having to sweep through a large quantity of beams to identify a beam (e.g., the beam having a highest signal quality)). In addition, QCL relationships may exist for both uplink and downlink transmissions and, in some cases, a QCL relationship may also be referred to as spatial relationship information.

In some examples, transmission configuration indicator (TCI) states may include one or more parameters associated with a QCL relationship between transmitted signals. For example, each TCI state includes parameters for configuring a QCL relationship between one or two downlink reference signals and the DMRS ports of PDSCH, the DMRS port of PDCCH or the CSI-RS port(s) of a CSI-RS resource. The QCL relationship is configured by a first higher layer parameter for the first downlink reference signal, and by a second higher layer parameter for the second downlink reference signal (if configured). That is, a network entity 105 may configure a QCL relationship that provides a mapping between a reference signal and antenna ports of another signal, and the TCI state may be indicated to the UE 115 by the network entity 105. In some cases, a set of TCI states (e.g., a list of TCI states) may be indicated to a UE 115 via RRC signaling, where some quantity of TCI states may be configured via RRC and one or more TCI states may be indicated (e.g., activated) via a medium access control (MAC)-control element (MAC-CE), and further indicated via DCI (e.g., within a CORESET). The QCL relationship associated with the TCI state (and further established through higher-layer parameters) may provide the UE 115 with the QCL relationship for respective antenna ports and reference signals transmitted by the network entity 105.

In some wireless communications systems (e.g., the wireless communications system 100), a UE 115 may perform a handover procedure to switch connections between one or more serving cells (e.g., associated with one or more network entities 105). For example, the UE 115 may communicate with a first serving cell that the UE 115 previously established a connection with, and the UE 115 may determine to switch connections to a candidate target cell (e.g., due to identifying an improvement in the connection with the candidate target cell relative to the first serving cell). In some cases, the handover procedure may be initiated by the UE 115, for example in an LTM cell switch, among other types of handover procedures (e.g., a conditional handover (CHO), or any other suitable handover procedure). As part of communicating with the first serving cell, the UE 115 may report information, such as information related to one or more beams used by the UE 115 for communications, to the first serving cell in a CSI report. Additionally, to support the cell switch, the UE 115 may measure and report information associated with one or more candidate cells available for the UE 115 to switch to (e.g., acquiring CSI for the one or more candidate cells). However, acquiring the CSI for the candidate cells may incur significant overhead, for example due to performing measurements for a large quantity of serving cells and corresponding TCI states. Further, CSI information for the candidate cells may become outdated while the UE 115 performs the cell switch procedure, which may adversely impact the connection between the UE 115 and a candidate target cell (e.g., due to changing channel conditions).

Techniques described herein provide for a UE 115 to perform two-stage CSI reporting for candidate cells as part of a switch, which may mitigate measurement and reporting overhead as well as enable a candidate target cell to obtain a CSI update sooner relative to executing the cell switch. For example, the UE 115 may measure CSI reference signals from candidate cells and may transmit a stage 1 CSI report to a current serving cell that indicates coarse channel status information (e.g., information capturing a relatively large scale channel status, such as a wideband channel status) for the candidate cells. The stage 1 CSI report may include a first format for indicating one or more unit stage 1 CSI reports (e.g., the final stage 1 CSI report may include aggregated unit stage 1 CSI reports) that each include respective pairs of information (e.g., measurement information) associated with a candidate cell and a CSI resource. In some cases, a payload of each unit stage 1 CSI report may be reduced (e.g., relative to a standard CSI report), for example by including a subset of CSI parameters, including only CSI part 1, or quantizing CSI parameters which may reduce overhead associated with indicating the stage 1 CSI report. The UE 115 may transmit, after the stage 1 CSI report, a stage 2 CSI report that indicates fine channel status information (e.g., information capturing a small scale channel status, such as sub-band channel status and/or channel variations relative to the stage 1 CSI report) for the candidate cells. For example, the stage 2 CSI report may include a second format (e.g., different from the first format of the stage 1 CSI report, for example including fine channel status information relative to the stage 1 CSI report) for indicating one or more stage 2 unit CSI reports including the respective pairs of information associated with candidate cells and CSI resources. Such techniques may enable candidate cells to acquire CSI information as-needed, for example obtaining the fine channel status information shortly before or after an cell switch, (e.g., to ensure or otherwise support an improved connection between the UE and a candidate target cell relative to a previous serving cell).

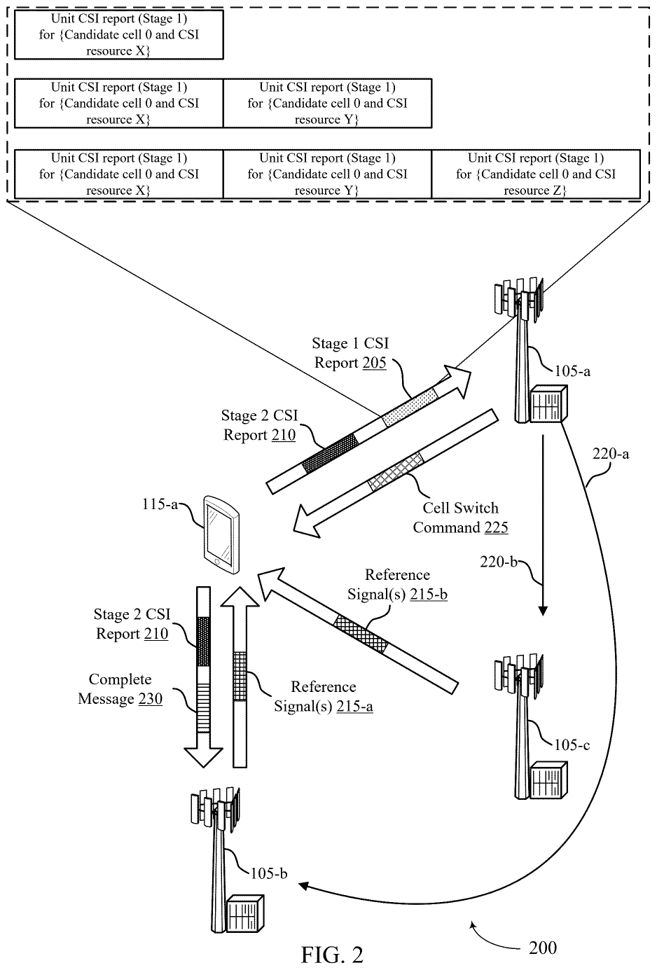

FIG. 2 shows an example of a wireless communications system 200 that supports two stage CSI reporting in accordance with one or more aspects of the present disclosure. The wireless communications system 200 may implement, or be implemented by, one or more aspects of the wireless communications system 100. For example, the wireless communications system 200 illustrates signaling between and operations by a UE 115-a and one or more network entities 105 (e.g., a network entity 105-a, a network entity 105-b, and a network entity 105-c), which may be examples of corresponding devices described with reference to FIG. 1. In some examples, the wireless communications system 200 may support the UE 115-a performing a handover procedure, such as an LTM cell switch, among other types of handovers (e.g., a CHO, or any other suitable handover procedure). Additionally, the wireless communications system 200 may support the UE 115-a performing a two-stage CSI reporting procedure to acquire and report CSI associated with one or more candidate cells for the LTM cell switch. As described herein, the LTM cell switch may be an example of a handover procedure where the serving cell of the UE 115-a is changed via L1 or L2 signaling, while upper layer (e.g., L3) configurations may be maintained or otherwise be minimally impacted by the cell switch. It should be noted that while the wireless communications system 200 illustrates two candidate cells for the LTM cell switch, the techniques described herein may be applicable to any quantity of candidate cells (e.g., candidate target cells, neighboring cells) available for the LTM cell switch. Additionally, or alternatively, the described techniques may be applicable to any type of handover or cell switch procedure (e.g., a CHO procedure, other types of cell switch procedures), and are not limited to LTM cell switch procedures.

The UE 115-a may be connected with and communicate with the network entity 105-a, which may correspond to a first serving cell that the UE 115-a previously established a connection with. In some examples, the UE 115-a, the network entity 105-a, or both may determine to initiate a handover procedure to switch a cell the UE 115-a is connected with. For example, the UE 115-a may transmit, to the network entity 105-a, a measurement report (e.g., indicating L1 reference signal received power (RSRP) measurements) indicating information associated with one or more beams used by the UE 115-a for communicating with the first serving cell and one or more candidate cells (e.g., neighboring cells associated with the network entity 105-b and the network entity 105-c). In some examples, based on the measurement report, the network entity 105-a may determine to initiate an LTM cell switch to switch the UE 115-a from being connected with the first serving cell to being connected with one of the candidate cells. In some cases, conditions (e.g., events) which trigger transmission of the measurement report by the UE 115-a and which trigger initiation of the LTM cell switch may be similar. For example, the conditions may include the quality of a first beam used by the UE 115-a to communicate with the first serving cell being below a configured threshold, a quality of a second beam associated with a candidate cell being a threshold value better than the first beam, a quality of the second beam exceeding a configured threshold, a quality of the first beam being below a first threshold and a quality of the second beam being greater than a second threshold, or any combination thereof.

In some examples, to indicate information associated with the candidate cells, the UE 115-a may measure and report CSI associated with the candidate cells (e.g., before or during the LTM cell switch process). However, acquiring the CSI for the candidate cells may incur relatively high signaling overhead, such as when the UE 115-a performs measurements for a large quantity of candidate cells and corresponding TCI states, particularly when the UE 115-a reports the CSI for the candidate cells relatively frequently. Further, acquiring the CSI for the candidate cells prior to receiving an LTM cell switch command (e.g., from the network entity 105-a after determining to initiate the LTM cell switch) may result in the reported CSI becoming outdated while the UE 115-a executes the LTM switch (e.g., due to changing channel conditions between the UE 115-a and the candidate cells), for example when the UE 115-a reports the CSI for the candidate cells less frequently to reduce signaling overhead.

To acquire and report CSI for candidate cells while mitigating signaling overhead and ensuring up-to-date CSI before or during an LTM cell switch, the UE 115-a may perform a two-stage CSI reporting procedure. The two-stage CSI reporting procedure may include the UE 115-a transmitting a stage 1 CSI report 205 that indicates rough channel status information for the candidate cells (e.g., large-scale channel status, such as a wideband channel status) and transmitting, after the stage 1 CSI report 205, a stage 2 CSI report 210 that indicates fine channel status information for the candidate cells (e.g., small-scale channel status, such as subband channel status, channel variations relative to the stage 1 CSI report 205, or both). Such techniques may reduce signaling overhead associated with reporting CSI for the candidate cells while enabling a candidate cell (e.g., a candidate target cell for the handover) to obtain a CSI update relatively soon after the UE 115-a executes the LTM cell switch.

The UE 115-a may receive one or more sets of reference signals 215 (e.g., CSI reference signals) from the one or more candidate cells. For example, the UE 115-a may receive one or more reference signals 215-a from the network entity 105-b and may receive one or more reference signals 215-b from the network entity 105-c. In some cases, the UE 115-a may use the reference signals 215 to generate one or more unit stage 1 CSI reports to be included in the stage 1 CSI report 205. Each unit stage 1 CSI report (e.g., a portion of a stage 1 CSI report, a sub-report of a stage 1 CSI report) may include CSI (e.g., measurement information) for a respective pair of a candidate cell and a CSI resource (e.g., corresponding to one of the reference signals 215). For example, the UE 115-a may generate a first unit stage 1 CSI report including CSI for the network entity 105-b and a first reference signal 215-a (e.g., the first unit stage 1 CSI report may indicate measurement information for {Candidate cell 0, CSI resource X}). Additionally, or alternatively, the UE 115-a may generate a second unit stage 1 CSI report including CSI for the network entity 105-b and a second reference signal 215-a (e.g., the second stage 1 CSI report may indicate measurement information for {Candidate cell 0, CSI resource Y}), may generate a third unit stage 1 CSI report including CSI for the network entity 105-c and a first reference signal 215-b (e.g., the third unit stage 1 CSI report may indicate measurement information for {Candidate cell 0, CSI resource Z}), or both. The UE 115-a may include one or more of the generated unit stage 1 CSI reports to obtain the (final) stage 1 CSI report 205. As an example, the stage 1 CSI report 205 may include a single report for a candidate cell and a CSI resource. Additionally, or alternatively, the unit stage 1 reports may be aggregated such that the stage 1 CSI report 205 includes multiple reports for a single candidate cell and multiple CSI resources, or multiple reports for multiple candidate cells and multiple CSI resources, or any combination thereof.

In some examples, the network entity 105-a may transmit, to the UE 115-a, a message including a configured list of candidate cell and CSI resource pairs that the UE 115-a is to include in the stage 1 CSI report. For example, the UE 115-a may determine which pairs of candidate cells and CSI resources to measure and generate unit stage 1 CSI reports for according to the list received from the network entity 105-a. In some examples, the UE 115-a may determine to omit one or more unit stage 1 CSI reports corresponding to one or more pairs included in the list based on measurements associated with the one or more pairs. For example, the UE 115-a may determine, for a first pair of a candidate cell and a CSI resource included in the configured list, that a measurement for the first pair is invalid (e.g., does not satisfy a quality threshold, among other examples), and may not include a unit stage 1 CSI report for the first pair in the stage 1 CSI report 205.

As described herein, the stage 1 CSI report 205 may include coarse (e.g., rough or relatively imprecise) channel status information associated with the candidate cells, for example by including relatively less information (e.g., in comparison to a standard CSI report), information that is relatively less sensitive to channel time evolution (e.g., channel conditions changing over time), or both. In some cases, the stage 1 CSI report 205 may have a first format for indicating the one or more unit stage 1 CSI reports that include the coarse channel status information. For example, the first format may define a payload of each unit stage 1 CSI report.

As an example, in accordance with the first format, each unit stage 1 CSI report may include a subset of parameters included in a standard CSI report. For example, each unit stage 1 CSI report may indicate, for a corresponding pair of a candidate cell and a CSI resource, a wideband PMI and a channel quality indicator (CQI). In such examples, rank information may be configured via RRC signaling (e.g., explicitly as part of CSI report configuration signaling) or may be implicitly defined (e.g., a specific or hardcoded value or assumed to be a lowest rank value). Alternatively, each unit stage 1 CSI report may indicate a rank indicator and a CQI, which may provide a rough spectral efficiency the UE 115-a expects from each pair of a candidate cell and a CSI resource. In such examples, precoding information (e.g., PMI) may be omitted from the stage 1 CSI report 205 and may instead be included in the stage 2 CSI report 210. Additionally, or alternatively, a PMI codebook type (e.g., type 1, type 2, single-panel, multi-panel) for the UE 115-a may be defined (e.g., hardcoded) as a certain type without receiving an explicit RRC configuration indicating the PMI codebook type.

As another example, in accordance with the first format, each unit stage 1 CSI report may include CSI parameters with a reduced resolution. For example, the UE 115-a may quantize one or more CSI parameters included in each unit stage 1 CSI report to reduce a quantity of bits used to convey each CSI parameter (e.g., indicating relatively low-resolution CSI parameters). In some cases, the UE 115-a may quantize the PMI, the CQI, or both included in each unit stage 1 CSI report. Additionally, or alternatively, if each unit stage 1 CSI report includes a subset of CSI parameters, the UE 115-a may quantize applicable CSI parameters (e.g., PMI or CQI) included in the subset of CSI parameters. In some cases, quantizing the one or more CSI parameters may be based on the first format defining a report quantity type (e.g., indicating to include a relatively lower quantity of bits relative to a standard CSI report). In such examples, information associated with the one or more CSI parameters may be refined via information included in the stage 2 CSI report 210.

As another example, in accordance with the first format, each unit stage 1 CSI report may include a first part of a two-part CSI reporting configuration (e.g., CSI part 1). For example, a second part of the two-part CSI reporting configuration (e.g., CSI part 2) may be omitted from the stage 1 CSI report 205 and may instead be included in the stage 2 CSI report 210. As another example, in accordance with the first format, each unit stage 1 CSI report may include a standard CSI report (e.g., indicating a full set of CSI parameters with full resolution) and the stage 2 CSI report 210 may indicate a difference for parameters included in the stage 1 CSI report 205 (e.g., the stage 2 CSI report 210 may update the information in the stage 1 CSI report 205 via delta-signaling).

In some examples, the first format may indicate a quantity of unit stage 1 CSI reports that may occupy a CSI processing unit at the UE 115-a (e.g., processing resources available at the UE 115-a for processing CSI reports). For example, the first format may indicate that more than one unit stage 1 CSI reports may occupy an integer quantity of CSI processing units, such as two unit stage 1 CSI reports occupying one CSI processing unit (e.g., one unit stage 1 CSI report may occupy one half of a CSI processing unit at the UE 115-a). In some cases, allowing multiple unit stage 1 CSI reports to occupy one CSI processing unit may reduce processing overhead at the UE 115-a, for example relative to a standard CSI report where a single CSI report may occupy one CSI processing unit.

In some cases, the UE 115-a may transmit the stage 1 CSI report 205 to the network entity 105-a (e.g., the current serving cell for the UE 115-a prior to the cell switch). For example, the UE 115-a may include the stage 1 CSI report 205 in an uplink control information (UCI) message, a MAC control element (MAC-CE), or both transmitted to the network entity 105-a. The network entity 105-a may indicate, to the UE 115-a, a configuration including one or more parameters for transmitting the stage 1 CSI report 205 (e.g., a report type for the stage 1 CSI report 205). For example, the configuration may indicate that the UE 115-a is to transmit the stage 1 CSI report 205 according to a first periodicity, semi-persistently, in response to reception of a trigger (e.g., aperiodically), in response to an occurrence of one or more events (e.g., event triggered), or any combination thereof. In some cases, if the configuration indicates to transmit the stage 1 CSI report 205 in response to the occurrence of one or more events (e.g., a UE-initiated report), the one or more events may include event conditions configured for a UE-initiated beam report, such that event triggers for the UE-initiated beam report may be used (e.g., reused or otherwise repurposed) to initiate the stage 1 CSI report 205. In some examples, the network entity 105-a may transmit the stage 1 CSI report 205 to the candidate cells based on receiving the stage 1 CSI report 205 from the UE 115-a. For example, the network entity 105-a may forward the stage 1 CSI report to the network entity 105-b via a connection 220-a (e.g., a backhaul link) and may forward the stage 1 CSI report to the network entity 105-c via a connection 220-b (e.g., a backhaul link). Alternatively, the network entity 105-a may refrain from forwarding the stage 1 CSI report 205 to the candidate cells until the network entity 105-a receives the stage 2 CSI report 210, where the network entity 105-a may combine the stage 1 CSI report 205 and the stage 2 CSI report 210 before forwarding the combined report to the candidate cells.

As described herein, the stage 2 CSI report 210 may include fine (e.g., relatively more precise in comparison to the stage 1 CSI report 205) channel status information associated with the candidate sells. For example, the stage 2 CSI report 210 may include incremental and relatively more accurate information in comparison to the stage 1 CSI report 205, such as information that is relatively more sensitive to channel time evolution, delta-signaling relative to information included in the stage 1 CSI report 205, or both. In some cases, the stage 2 CSI report 210 may have a second format for indicating one or more unit stage 2 CSI reports that include the fine channel status information, which may be different from the first format associated with the stage 1 CSI report 205. For example, the second format may define a payload of each unit stage 2 CSI report. In some cases, each unit stage 2 CSI report may include CSI (e.g., measurement information) for a respective pair of a candidate cell and a CSI resource. For example, each unit stage 2 CSI report may correspond to a unit stage 1 CSI report included in the stage 1 CSI report 205, and may include information that refines, completes, or expands on (or any combination thereof) information included in a corresponding unit stage 1 CSI report.

As an example, in accordance with the second format, if a unit stage 1 CSI report indicates a wideband PMI and a CQI for a pair of a candidate cell and a CSI resource, a corresponding unit stage 2 CSI report may include a subband PMI and a CQI for the pair. In some examples, the CQI may be updated relative to the CQI indicated in the corresponding unit stage 1 CSI report, such as if the UE 115-a measures a new reference signal 215 (e.g., corresponding to the CSI resource of the pair) after transmitting the stage 1 CSI report 205. Alternatively, if a unit stage 1 CSI report indicates a rank indicator and a CQI for a pair of a candidate cell and a CSI resource, a corresponding unit stage 2 CSI report may include a wideband PMI or a subband PMI, or both, and a CQI for the pair, where the CQI may be updated relative to the corresponding unit stage 1 CSI report (e.g., if the UE 115-a measures a new reference signal 215 for the CSI resource).

As another example, in accordance with the second format, each unit stage 2 CSI report may include a second part of a two-part CSI reporting configuration (e.g., CSI part 2). For example, if a unit stage 1 CSI report includes a first part of the two-part CSI reporting configuration, a corresponding unit stage 2 CSI report may include the second part of the two-part CSI reporting configuration, where the UE 115-a may generate the second part conditioned on the information of the first part included in the corresponding unit stage 1 CSI report.

As another example, in accordance with the second format, each unit stage 2 CSI report may include delta values relative to a corresponding unit stage 1 CSI report. For example, if a unit stage 1 CSI report includes one or more CSI parameters with reduced resolution (e.g., quantized parameters), a corresponding unit stage 2 CSI report may include information that increases the resolution (e.g., provides a finer granularity) of the one or more CSI parameters. Alternatively, if a unit stage 1 CSI report includes a standard CSI report, a corresponding unit stage 2 CSI report may include values indicating differences from CSI parameters included in the unit stage 1 CSI report (e.g., updating for current channel conditions using delta-signaling).

In some examples, the network entity 105-a may indicate, to the UE 115-a, a second configuration including one or more parameters for transmitting the stage 2 CSI report 210. In some cases, the network entity 105-a may indicate the second configuration in the same message that indicates the configuration for transmitting the stage 1 CSI report 205 or in a different message. The one or more parameters of the second configuration and the one or more parameters of the configuration for transmitting the stage 1 CSI report 205 may be the same (e.g., the stage 1 CSI report 205 and the stage 2 CSI report 210 may share a common transmission configuration) or may be different (e.g., the stage 1 CSI report 205 and the stage 2 CSI report 210 may have different transmission configurations).

If the stage 1 CSI report 205 and the stage 2 CSI report 210 share a common transmission configuration, a report quantity associated with the stage 1 CSI report 205 and the stage 2 CSI report 210 may be commonly set by the network entity 105-a. For example, the network entity 105-a may indicate a set of CSI parameters that should be indicated across the stage 1 CSI report 205 and the stage 2 CSI report 210 (e.g., rank indicator, wideband PMI, subband PMI, and CQI), and the UE 115-a may divide the report quantities between the stage 1 CSI report 205 and the stage 2 CSI report 210 (e.g., the unit stage 2 CSI reports may include report quantities omitted from corresponding unit stage 1 CSI reports). Additionally, or alternatively, a report type associated with stage 1 CSI report 205 and the stage 2 CSI report 210 may be commonly set by the network entity 105-a (e.g., an RRC configuration may have a common parameter applied to both stage configurations). For example, the network entity 105-a may configure both the stage 1 CSI report 205 and the stage 2 CSI report 210 to be transmitted periodically or semi-persistently. In such examples, the network entity 105-a may indicate a time offset between transmission of the stage 1 CSI report 205 and the stage 2 CSI report 210, different periodicities between the stage 1 CSI report 205 and the stage 2 CSI report 210 (e.g., the stage 2 CSI report 210 may have a shorter periodicity due to being more time-sensitive), or both.

If the stage 1 CSI report 205 and the stage 2 CSI report have different transmission configurations, the network entity 105-a may configure different report types between the stage 1 CSI report 205 and the stage 2 CSI report 210. For example, the network entity 105-a may configure the stage 1 CSI report 205 to be transmitted according to a periodicity and may configure the stage 2 CSI report 210 to be transmitted in response to a trigger (e.g., aperiodically).

In some cases, the UE 115-a may transmit the stage 2 CSI report 210 to the network entity 105-a, the network entity 105-b, the network entity 105-c, or any combination thereof. For example, the UE 115-a may include the stage 2 CSI report 210 in a UCI message, a MAC-CE, or both transmitted to the current serving cell, directly to the candidate target cell for the switch, or both. In some examples, the network entity 105-a may configure the UE 115-a to send the stage 2 CSI report 210 to the network entity 105-a (e.g., CSI acquisition may be performed before the UE 115-a receives a cell switch command). If the UE 115-a transmits the stage 2 CSI report 210 to the network entity 105-a, the network entity 105-a may separately forward the stage 1 CSI report 205 and the stage 2 CSI report 210 to the network entity 105-b and the network entity 105-c (e.g., via the connection 220-a and the connection 220-b, respectively). In such examples, each candidate cell may be responsible for deriving the complete CSI from the stage 1 CSI report 205 and the stage 2 CSI report 210. Alternatively, the network entity 105-a may combine the stage 1 CSI report 205 and the stage 2 CSI report 210 after receiving the stage 2 CSI report 210, and may forward the complete CSI to the candidate cells. In some cases, the network entity 105-a may configure the UE 115-a to transmit the stage 2 CSI report 210 in response to a cell switch command 225 (e.g., reception of the cell switch command 225 (e.g., an LTM cell switch command) may trigger transmission of the stage 2 CSI report 210). For example, the UE 115-a may multiplex the stage 2 CSI report 210 with a feedback message for the cell switch command 225 or other types of control signaling (e.g., multiplexed with HARQ-ACK feedback within a UCI message, multiplexed within a PUSCH message as UCI or MAC-CE). In such examples, the network entity 105-a may expect to receive both the feedback and the stage 2 CSI report 210 in a UCI message.

In some other examples, the UE 115-a may transmit the stage 2 CSI report 210 to a candidate target candidate cell for the cell switch. For example, if the network entity 105-a indicates for the UE 115-a to perform the cell switch and switch to connecting with the network entity 105-b, the UE 115-a may transmit the stage 2 CSI report 210 to the network entity 105-b. In some cases, the UE 115-a may transmit the stage 2 CSI report 210 to the network entity 105-b along with a complete message 230 (e.g., an uplink message sent to the network entity 105-b after the cell switch). The complete message 230 may be an example of an RRC reconfiguration complete message or a random access channel (RACH) message (e.g., RACH message 3 or RACH message A). The UE 115-a may include the stage 2 CSI report 210 with the complete message 230 by multiplexing a UCI message including the stage 2 CSI report 210 with a physical uplink shared channel (PUSCH) data message or appending a MAC-CE including the stage 2 CSI report to a MAC protocol data unit (PDU). In some cases, the stage 2 CSI report 210 transmitted to the network entity 105-b may omit CSI related to other serving cells (e.g., CSI related to the network entity 105-c).

By implementing the two-stage CSI reporting procedure, the UE 115-a may support CSI acquisition for candidate cells before or during a cell switch, while mitigating signaling overhead associated with the CSI acquisition and enabling a candidate target candidate cell to obtain CSI relatively soon after execution of the cell switch.

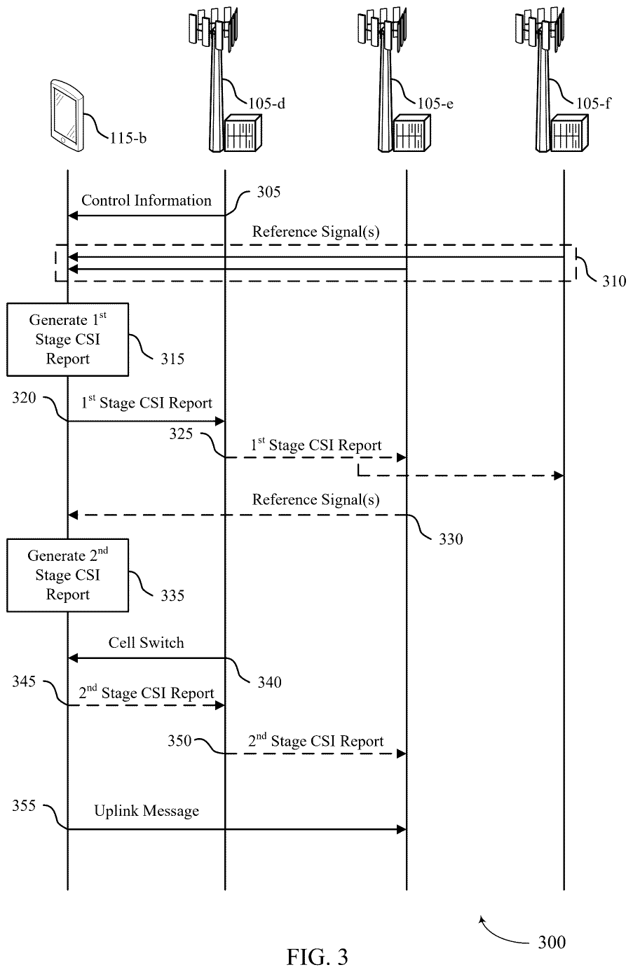

FIG. 3 shows an example of a process flow 300 that supports two stage CSI reporting in accordance with one or more aspects of the present disclosure. The process flow 300 may implement, or be implemented by, one or more aspects of the wireless communications system 100 and the wireless communications system 200. For example, the process flow 300 illustrates signaling and operations by a UE 115-b and one or more network entities 105 (e.g., a network entity 105-d, a network entity 105-e, and a network entity 105-f), which may be examples of corresponding devices described with reference to FIGS. 1 and 2. In some examples, the process flow 300 may support the UE 115-b acquiring and reporting CSI associated with one or more candidate cells (e.g., associated with the network entity 105-e and the network entity 105-f) before or during a cell switch. Alternative examples of the following may be implemented, where some processes are performed in a different order than described or are not performed. In some cases, processes may include additional features not mentioned below, or further processes may be added.

At 305, the network entity 105-d may transmit, to the UE 115-b, one or more messages including control information. For example, the control information may include a first configuration of first stage CSI report (which may be referred to as a stage 1 CSI report), a second configuration of a second stage CSI report (which may be referred to as a stage 2 CSI report), or both. The first configuration may indicate for the UE 115-b to transmit the first stage CSI report according to a first periodicity, semi-persistently, in response to reception of a first trigger (e.g., aperiodically), in response to an occurrence of one or more events, or any combination thereof.

In some examples, one or more parameters of the second configuration may be the same as one or more parameters of the first configuration. For example, the second configuration may indicate for one or more second unit CSI reports included in the second stage CSI report to include one or more report quantities (e.g., CSI parameters) that are omitted from corresponding ones of one or more first unit CSI reports included in the first stage CSI report, for the UE 115-b to transmit the second stage CSI report aperiodically or in accordance with a second periodicity, one or more time offset values (which may be additionally, or alternatively, included in the first configuration) between the first stage CSI report and the second stage CSI report, or any combination thereof.

In some other examples, the one or more parameters of the second configuration may be different from the one or more parameters of the first configuration. For example, the one or more parameters of the second configuration may include a first reporting type that is different from a second reporting type indicated by the one or more parameters of the first configuration (e.g., the second stage CSI report may be transmitted aperiodically and the first stage CSI report may be transmitted periodically).

In some examples, the control information may include a message that indicates a list of respective pairs of information each including a candidate cell and a CSI resource to be included in the first stage CSI report.

At 310, the UE 115-b may receive, from the network entity 105-e and the network entity 105-f, one or more reference signals. The one or more reference signals may be associated with one or more candidate cells for a cell switch (e.g., the network entity 105-e and the network entity 105-f).

At 315, the UE 115-b may generate the first stage CSI report. For example, the UE 115-b may generate one or more first unit CSI report based on measurements of the one or more reference signals, and may aggregate the one or more first unit CSI reports to obtain the first stage CSI report. In some cases, the UE 115-b may generate at least two first unit CSI reports using an integer quantity of CSI processing units of the UE 115-b (e.g., one first unit CSI report may occupy a portion of a CSI processing unit). In some cases, each unit CSI report of the one or more first unit CSI reports may indicate CSI for respective pairs of information each including a candidate cell and a CSI resource. The UE 115-b may obtain CSI measurements associated with each pair indicated in the list of respective pairs received from the network entity 105-d. In some cases, the UE 115-b may omit or exclude a first pair included in the list of respective pairs based on a CSI measurement associated with the first pair being invalid.

In some examples, the first stage CSI report may include a first format for indicating the one or more first unit CSI reports. In some cases, the first format may be associated with reporting, in each first unit CSI report, a wideband PMI and a rank indicator. In some examples, the first format may be associated with reporting, in each first unit CSI report, a rank indicator and a CQI. In some cases, the first format may be associated with reporting, in each first unit CSI report, a first part of a two-part CSI (e.g., CSI part 1). In some cases, the first format may be associated with reporting, in each first unit CSI report, quantized CSI parameters (e.g., the UE 115-b may quantize one or more CSI parameters for each first unit CSI report). In some cases, the first format may be associated with reporting, in each first unit CSI report, a first CSI in a standard CSI report (e.g., where a second format for the second stage CSI report may be associated with reporting a difference for one or more parameters relative to the corresponding ones of the first CSI). For example, the first format may be associated with a first resolution of CSI (e.g., that is less than a second resolution associated with the second format).

At 320, the UE 115-b may transmit the first stage CSI report to the network entity 105-d. In some cases, the UE 115-b may transmit the first stage CSI report via a UCI message or via a MCA-CE. The UE 115-b may transmit the first stage CSI report in accordance with the first configuration. As described herein, the first stage CSI report may indicate coarse CSI, for example information that is relatively less sensitive to channel time evolution.

At 325, the network entity 105-d may forward the first stage CSI report to the network entity 105-e, the network entity 105-f, or both. In some cases, the network entity 105-d may refrain from forwarding the first stage CSI report until the network entity 105-d receives the second stage CSI report (e.g., the network entity 105-d may forward a combined CSI report).

At 330, the UE 115-b may receive one or more reference signals. For example, the UE 115-b may receive the one or more reference signals from a candidate target cell for the cell switch (e.g., the network entity 105-e).

At 335, the UE 115-b may generate the second stage CSI report. In some examples, the UE 115-b may generate the second stage CSI report using measurements of the one or more reference signals received at 330. The second stage CSI report may include a second format for indicating one or more second unit CSI reports. In some examples, each unit CSI report of the one or more second unit CSI reports may indicate CSI for respective pairs of information each including a candidate cell and a CSI resource.

In some cases, the second format may be associated with reporting, in each second unit CSI report, a sub-band PMI and a CQI. In some cases, the second format may be associated with reporting, in each second unit CSI report, a sub-band PMI, a wideband PMI, a CQI, or any combination thereof. In some cases, the second format may be associated with reporting, in each second unit CSI report, a second part of a two-part CSI (e.g., CSI part 2). In some cases, the second format may be associated with reporting, in each second unit CSI report, CSI parameters omitted from corresponding ones of the one or more first unit CSI reports.

At 340, the UE 115-b may receive a cell switch command from the network entity 105-d. For example, the network entity 105-d may transmit the cell switch command to initiate the cell switch to switch the UE 115-b to connect with the network entity 105-e.

At 345, the UE 115-b may transmit the second stage CSI report to the network entity 105-d. For example, the UE 115-b may transmit the second stage CSI report in a UCI message multiplexed with a feedback message in response to the cell switch command. Additionally, or alternatively, the UE 115-b may transmit the second stage CSI report via a MAC-CE.

At 350, the network entity 105-d may forward the second stage CSI report to the network entity 105-e. Additionally, in some examples, the network entity 105-d may also forward the second stage CSI report to the network entity 105-f. The network entity 105-d may forward the second stage CSI report to the candidate cells separate from the first stage CSI report, or may forward a combined CSI report to the candidate cells including both the first stage CSI report and the second stage CSI report.

At 355, the UE 115-b may transmit an uplink message to the network entity 105-e (e.g., a candidate target cell for the cell switch). In some cases, the uplink message may include the second stage CSI report. For example, the uplink message may be an RRC reconfiguration complete message or a RACH message (e.g., RACH message 3 or RACH message A), and the UE 115-b may multiplex a UCI including the second stage CSI report with a PUSCH data message or may append a MAC-CE including the second stage CSI report to a MAC PDU.

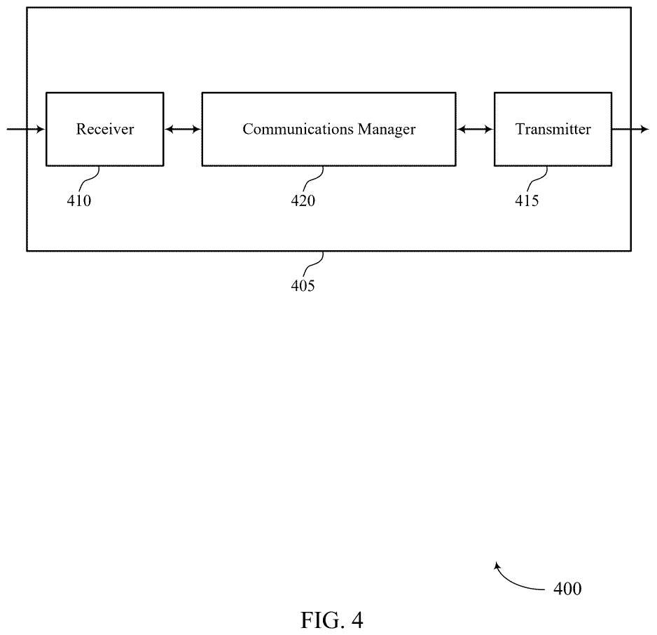

FIG. 4 shows a block diagram 400 of a device 405 that supports two stage CSI reporting in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to two stage CSI reporting). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to two stage CSI reporting). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of two stage CSI reporting as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, a GPU, a NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving one or more reference signals that are associated with one or more candidate cells. The communications manager 420 is capable of, configured to, or operable to support a means for transmitting, to a network entity, a first stage CSI report based on the one or more reference signals, where the first stage CSI report includes a first format for indicating one or more first unit CSI reports associated with the one or more candidate cells and one or more CSI resources. The communications manager 420 is capable of, configured to, or operable to support a means for transmitting, after transmission of the first stage CSI report, a second stage CSI report based on the first stage CSI report, where the second stage CSI report includes a second format for indicating one or more second unit CSI reports associated with the one or more candidate cells and the one or more CSI resources, the second format different from the first format.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reducing signaling overhead associated with acquiring CSI for candidate cells before or during a cell switch while enabling candidate cells to obtain the CSI relatively soon after the cell switch.

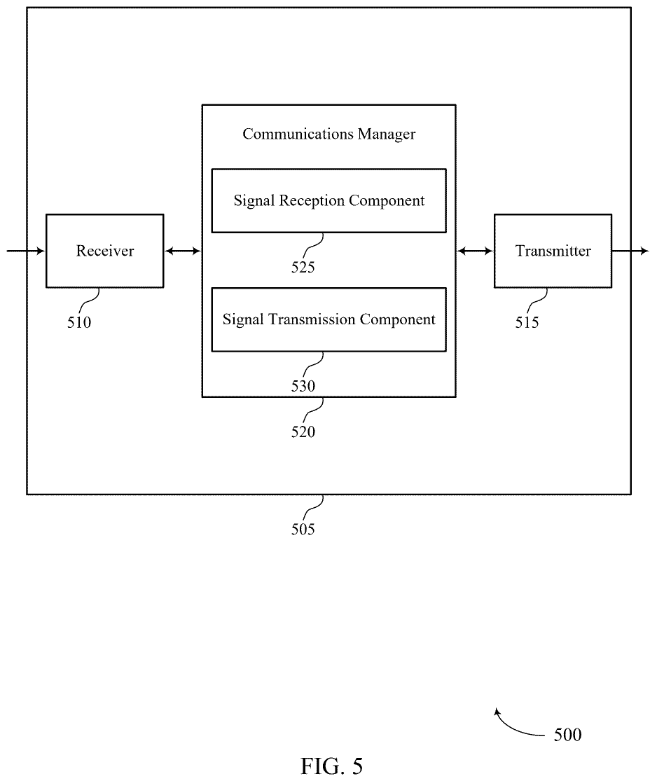

FIG. 5 shows a block diagram 500 of a device 505 that supports two stage CSI reporting in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to two stage CSI reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to two stage CSI reporting). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of two stage CSI reporting as described herein. For example, the communications manager 520 may include a signal reception component 525 a signal transmission component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The signal reception component 525 is capable of, configured to, or operable to support a means for receiving one or more reference signals that are associated with one or more candidate cells. The signal transmission component 530 is capable of, configured to, or operable to support a means for transmitting, to a network entity, a first stage CSI report based on the one or more reference signals, where the first stage CSI report includes a first format for indicating one or more first unit CSI reports associated with the one or more candidate cells and one or more CSI resources. The signal transmission component 530 is capable of, configured to, or operable to support a means for transmitting, after transmission of the first stage CSI report, a second stage CSI report based on the first stage CSI report, where the second stage CSI report includes a second format for indicating one or more second unit CSI reports associated with the one or more candidate cells and the one or more CSI resources, the second format different from the first format.

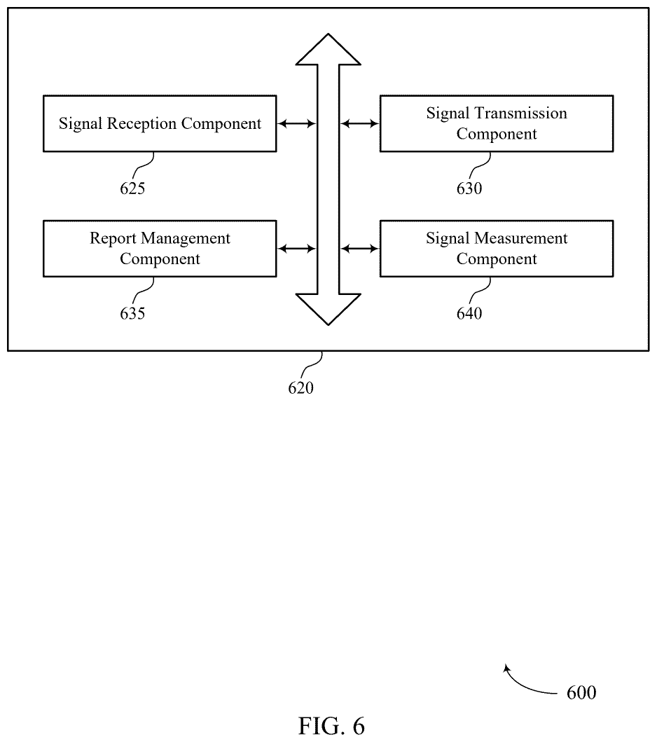

FIG. 6 shows a block diagram 600 of a communications manager 620 that supports two stage CSI reporting in accordance with one or more aspects of the present disclosure. The communications manager 620 may be an example of aspects of a communications manager 420, a communications manager 520, or both, as described herein. The communications manager 620, or various components thereof, may be an example of means for performing various aspects of two stage CSI reporting as described herein. For example, the communications manager 620 may include a signal reception component 625, a signal transmission component 630, a report management component 635, a signal measurement component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The signal reception component 625 is capable of, configured to, or operable to support a means for receiving one or more reference signals that are associated with one or more candidate cells. The signal transmission component 630 is capable of, configured to, or operable to support a means for transmitting, to a network entity, a first stage CSI report based on the one or more reference signals, where the first stage CSI report includes a first format for indicating one or more first unit CSI reports associated with the one or more candidate cells and one or more CSI resources. In some examples, the signal transmission component 630 is capable of, configured to, or operable to support a means for transmitting, after transmission of the first stage CSI report, a second stage CSI report based on the first stage CSI report, where the second stage CSI report includes a second format for indicating one or more second unit CSI reports associated with the one or more candidate cells and the one or more CSI resources, the second format different from the first format.

In some examples, the report management component 635 is capable of, configured to, or operable to support a means for generating the one or more first unit CSI reports based on measurements of the one or more reference signals. In some examples, the report management component 635 is capable of, configured to, or operable to support a means for aggregating the one or more first unit CSI reports to obtain the first stage CSI report, where transmitting the first stage CSI report is based on obtaining the first stage CSI report. In some examples, the report management component 635 is capable of, configured to, or operable to support a means for generating the one or more second unit CSI reports based on the one or more first unit CSI reports, measurements of the one or more reference signals, measurements one or more other reference signals, or any combination thereof. In some examples, the report management component 635 is capable of, configured to, or operable to support a means for aggregating the one or more second unit CSI reports to obtain the second stage CSI report, wherein transmitting the second stage CSI report is based on obtaining the second stage CSI report.

In some examples, to support generating the one or more first unit CSI reports, the report management component 635 is capable of, configured to, or operable to support a means for generating at least two first unit CSI reports of the one or more first unit CSI reports using an integer quantity of CSI processing units of the UE. In some examples, each unit CSI report of the one or more first unit CSI reports indicates CSI for respective pairs of information each including a candidate cell and a CSI resource.

In some examples, the signal reception component 625 is capable of, configured to, or operable to support a means for receiving, from the network entity, a message indicating a list of respective pairs of information each including a candidate cell and a CSI resource to be included in the first stage CSI report, where the first stage CSI report includes the one or more first unit CSI reports based on receiving the message.

In some examples, the signal measurement component 640 is capable of, configured to, or operable to support a means for obtaining a first CSI measurement associated with a first pair of the list of respective pairs, where the first stage CSI report excludes CSI associated with the first pair based on the first CSI measurement.

In some examples, the first format is associated with reporting a wideband PMI and a rank indicator for each of the one or more first unit CSI reports. In some examples, the first format is associated with reporting a rank indicator and a CQI for each of the one or more first unit CSI reports. In some examples, the first format is associated with reporting a first part of a two-part CSI associated with each of the one or more first unit CSI reports.

In some examples, the report management component 635 is capable of, configured to, or operable to support a means for quantizing one or more CSI parameters for each of the one or more first unit CSI reports, where the first format is associated with reporting the quantized one or more CSI parameters.

In some examples, the first format is associated with reporting first CSI for each of the one or more first unit CSI reports. In some examples, the second format is associated with reporting a difference for one or more parameters relative to the corresponding ones of the first CSI.

In some examples, the first stage CSI report is transmitted via a UCI message or via a MAC-CE, or any combination thereof. In some examples, each unit CSI report of the one or more second unit CSI reports indicates CSI for respective pairs of information each including a candidate cell and a CSI resource.

In some examples, the signal reception component 625 is capable of, configured to, or operable to support a means for receiving control information including a first configuration of the first stage CSI report, where the first configuration includes an indication to transmit the first stage CSI report according to a first periodicity, semi-persistently, in response to reception of a first trigger, in response to an occurrence of one or more events, or any combination thereof.

In some examples, the control information further includes a second configuration of the second stage CSI report. In some examples, one or more parameters of the second configuration are the same as one or more parameters of the first configuration.

In some examples, the one or more second unit CSI reports include one or more report quantities that are omitted from corresponding ones of the one or more first unit CSI reports; the second stage CSI report is transmitted aperiodically or in accordance with a periodicity, and the first configuration or the second configuration, or both, indicates one or more time offset values between the first stage CSI report and the second stage CSI report.

In some examples, the control information further includes a second configuration of the second stage CSI report. In some examples, one or more parameters of the second configuration are different from one or more parameters of the first configuration. In some examples, the one or more parameters of the second configuration include a first reporting type that is different from a second reporting type indicated by the one or more parameters of the first configuration.

In some examples, the second format is associated with reporting a sub-band PMI and a CQI for each of the one or more second unit CSI reports. In some examples, the second format is associated with reporting a sub-band PMI, a wideband PMI, or a CQI, or any combination thereof, for each of the one or more second unit CSI reports. In some examples, the second format is associated with reporting a second part of a two-part CSI associated with each of the one or more second unit CSI reports. In some examples, the second stage CSI report is transmitted via a UCI message or via a MAC-CE, or any combination thereof.

In some examples, to support transmitting the second stage CSI report, the signal transmission component 630 is capable of, configured to, or operable to support a means for transmitting the second stage CSI report to the network entity, to another network entity, or both.

In some examples, the first format is associated with a first resolution of CSI. In some examples, the second format is associated with a second resolution of the CSI, the second resolution being greater than the first resolution.

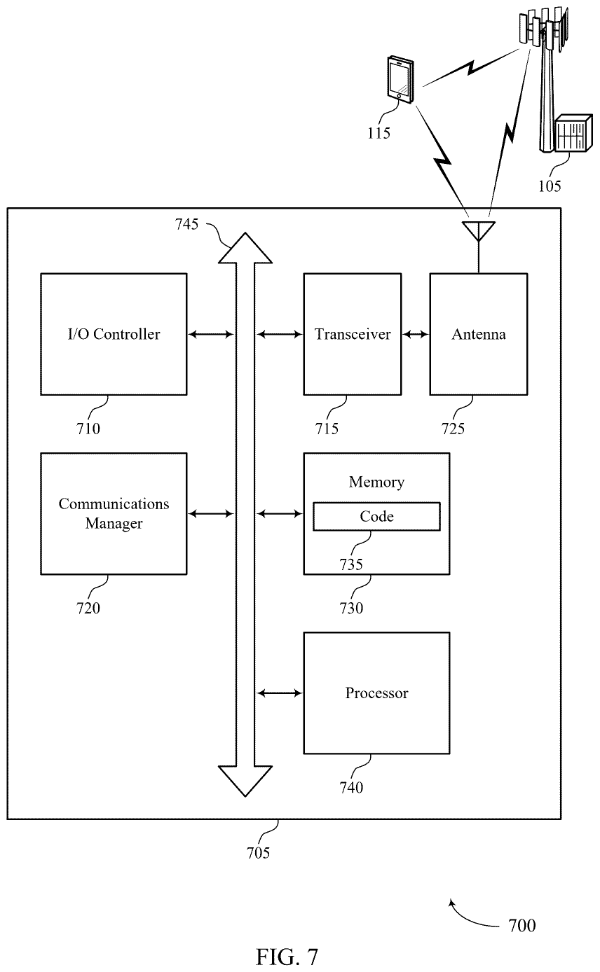

FIG. 7 shows a diagram of a system 700 including a device 705 that supports two stage CSI reporting in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting two stage CSI reporting). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving one or more reference signals that are associated with one or more candidate cells. The communications manager 720 is capable of, configured to, or operable to support a means for transmitting, to a network entity, a first stage CSI report based on the one or more reference signals, where the first stage CSI report includes a first format for indicating one or more first unit CSI reports associated with the one or more candidate cells and one or more CSI resources. The communications manager 720 is capable of, configured to, or operable to support a means for transmitting, after transmission of the first stage CSI report, a second stage CSI report based on the first stage CSI report, where the second stage CSI report includes a second format for indicating one or more second unit CSI reports associated with the one or more candidate cells and the one or more CSI resources, the second format different from the first format.

By including or configuring the communications manager 720 in accordance with examples as described herein, the device 705 may support techniques for reducing signaling overhead associated with acquiring CSI for candidate cells before or during a cell switch while enabling candidate cells to obtain the CSI relatively soon after the cell switch.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of two stage CSI reporting as described herein, or the at least one processor 740 and the at least one memory 730 may be otherwise configured to, individually or collectively, perform or support such operations.

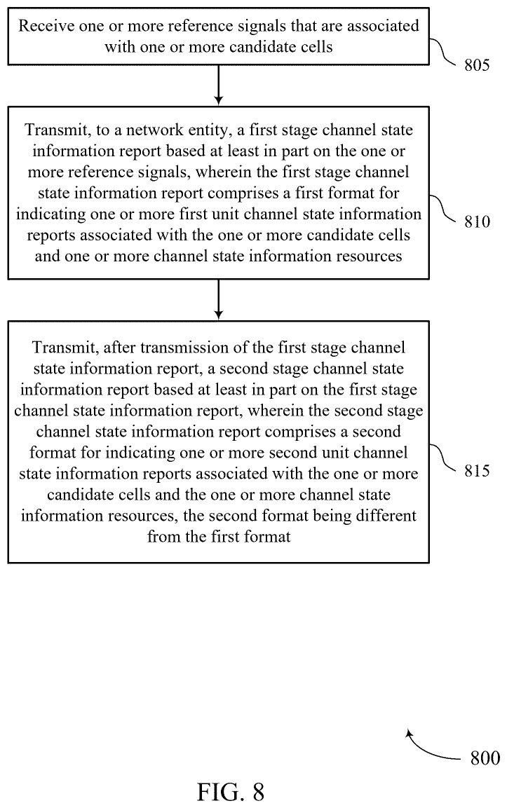

FIG. 8 shows a flowchart illustrating a method 800 that supports two stage CSI reporting in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving one or more reference signals that are associated with one or more candidate cells. The operations of 805 may be performed in accordance with examples as disclosed herein. In some examples, aspects of the operations of 805 may be performed by a signal reception component 625 as described with reference to FIG. 6.

At 810, the method may include transmitting, to a network entity, a first stage CSI report based on the one or more reference signals, where the first stage CSI report includes a first format for indicating one or more first unit CSI reports associated with the one or more candidate cells and one or more CSI resources. The operations of 810 may be performed in accordance with examples as disclosed herein. In some examples, aspects of the operations of 810 may be performed by a signal transmission component 630 as described with reference to FIG. 6.

At 815, the method may include transmitting, after transmission of the first stage CSI report, a second stage CSI report based on the first stage CSI report, where the second stage CSI report includes a second format for indicating one or more second unit CSI reports associated with the one or more candidate cells and the one or more CSI resources, the second format different from the first format. The operations of 815 may be performed in accordance with examples as disclosed herein. In some examples, aspects of the operations of 815 may be performed by a signal transmission component 630 as described with reference to FIG. 6.

The following provides an overview of aspects of the present disclosure:

Aspect 1: A method for wireless communications by a UE, comprising: receiving one or more reference signals that are associated with one or more candidate cells; transmitting, to a network entity, a first stage CSI report based at least in part on the one or more reference signals, wherein the first stage CSI report comprises a first format for indicating one or more first unit CSI reports associated with the one or more candidate cells and one or more CSI resources; and transmitting, after transmission of the first stage CSI report, a second stage CSI report based at least in part on the first stage CSI report, wherein the second stage CSI report comprises a second format for indicating one or more second unit CSI reports associated with the one or more candidate cells and the one or more CSI resources, the second format different from the first format.

Aspect 2: The method of aspect 1, further comprising: generating the one or more first unit CSI reports based at least in part on measurements of the one or more reference signals; and aggregating the one or more first unit CSI reports to obtain the first stage CSI report, wherein transmitting the first stage CSI report is based at least in part on obtaining the first stage CSI report.

Aspect 3: The method of aspect 2, wherein generating the one or more first unit CSI reports comprises: generating at least two first unit CSI reports of the one or more first unit CSI reports using an integer quantity of CSI processing units of the UE.

Aspect 4: The method of any of aspects 1 through 3, wherein each unit CSI report of the one or more first unit CSI reports indicates CSI for respective pairs of information each comprising a candidate cell and a CSI resource.

Aspect 5: The method of any of aspects 1 through 4, further comprising: receiving, from the network entity, a message indicating a list of respective pairs of information each comprising a candidate cell and a CSI resource to be included in the first stage CSI report, wherein the first stage CSI report includes the one or more first unit CSI reports based at least in part on receiving the message.

Aspect 6: The method of aspect 5, further comprising: obtaining a first CSI measurement associated with a first pair of the list of respective pairs, wherein the first stage CSI report excludes CSI associated with the first pair based at least in part on the first CSI measurement.

Aspect 7: The method of any of aspects 1 through 6, wherein the first format is associated with reporting a wideband PMI and a rank indicator for each of the one or more first unit CSI reports.

Aspect 8: The method of any of aspects 1 through 6, wherein the first format is associated with reporting a rank indicator and a CQI for each of the one or more first unit CSI reports.

Aspect 9: The method of any of aspects 1 through 8, wherein the first format is associated with reporting a first part of a two-part CSI associated with each of the one or more first unit CSI reports.

Aspect 10: The method of any of aspects 1 through 9, further comprising: quantizing one or more CSI parameters for each of the one or more first unit CSI reports, wherein the first format is associated with reporting the quantized one or more CSI parameters.

Aspect 11: The method of any of aspects 1 through 10, wherein the first format is associated with reporting first CSI for each of the one or more first unit CSI reports, and the second format is associated with reporting a difference for one or more parameters relative to the corresponding ones of the first CSI.

Aspect 12: The method of any of aspects 1 through 11, wherein the first stage CSI report is transmitted via a UCI message or via a MAC-CE, or any combination thereof.

Aspect 13: The method of any of aspects 1 through 12, wherein each unit CSI report of the one or more second unit CSI reports indicates CSI for respective pairs of information each comprising a candidate cell and a CSI resource.

Aspect 14: The method of any of aspects 1 through 13, further comprising: receiving control information comprising a first configuration of the first stage CSI report, wherein the first configuration comprises an indication to transmit the first stage CSI report according to a first periodicity, semi-persistently, in response to reception of a first trigger, in response to an occurrence of one or more events, or any combination thereof.

Aspect 15: The method of aspect 14, wherein the control information further comprises a second configuration of the second stage CSI report, and one or more parameters of the second configuration are the same as one or more parameters of the first configuration.

Aspect 16: The method of aspect 15, wherein the one or more parameters of the second configuration are the same as the one or more parameters of the first configuration, and wherein the one or more second unit CSI reports include one or more report quantities that are omitted from corresponding ones of the one or more first unit CSI reports; the second stage CSI report is transmitted aperiodically or in accordance with a periodicity, and the first configuration or the second configuration, or both, indicates one or more time offset values between the first stage CSI report and the second stage CSI report.

Aspect 17: The method of any of aspects 14 through 16, wherein the control information further comprises a second configuration of the second stage CSI report, and one or more parameters of the second configuration are different from one or more parameters of the first configuration.

Aspect 18: The method of aspect 17, wherein the one or more parameters of the second configuration comprise a first reporting type that is different from a second reporting type indicated by the one or more parameters of the first configuration.

Aspect 19: The method of any of aspects 1 through 18, wherein the second format is associated with reporting a sub-band PMI and a CQI for each of the one or more second unit CSI reports.

Aspect 20: The method of any of aspects 1 through 18, wherein the second format is associated with reporting a sub-band PMI, a wideband PMI, or a CQI, or any combination thereof, for each of the one or more second unit CSI reports.

Aspect 21: The method of any of aspects 1 through 20, wherein the second format is associated with reporting a second part of a two-part CSI associated with each of the one or more second unit CSI reports.

Aspect 22: The method of any of aspects 1 through 21, wherein the second stage CSI report is transmitted via a UCI message or via a MAC-CE, or any combination thereof.

Aspect 23: The method of any of aspects 1 through 22, wherein transmitting the second stage CSI report comprises: transmitting the second stage CSI report to the network entity, to another network entity, or both.

Aspect 24: The method of any of aspects 1 through 23, wherein the first format is associated with a first resolution of CSI, and the second format is associated with a second resolution of the CSI, the second resolution being greater than the first resolution.

Aspect 25: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 24.

Aspect 26: A UE for wireless communications, comprising at least one means for performing a method of any of aspects 1 through 24.

Aspect 27: A non-transitory computer-readable medium storing code for wireless communications, the code comprising instructions executable by one or more processors (e.g., directly, indirectly, after pre-processing, without pre-processing) to perform a method of any of aspects 1 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more reference signals that are associated with one or more candidate cells;
transmit, to a network entity, a first stage channel state information report based at least in part on the one or more reference signals, wherein the first stage channel state information report comprises a first format for indicating one or more first unit channel state information reports associated with the one or more candidate cells and one or more channel state information resources; and
transmit, after transmission of the first stage channel state information report, a second stage channel state information report based at least in part on the first stage channel state information report, wherein the second stage channel state information report comprises a second format for indicating one or more second unit channel state information reports associated with the one or more candidate cells and the one or more channel state information resources, the second format different from the first format.

2. The UE of claim 1, wherein the one or more processors are individually or collectively further operable to execute the code to cause the UE to:
generate the one or more first unit channel state information reports based at least in part on measurements of the one or more reference signals; and
aggregate the one or more first unit channel state information reports to obtain the first stage channel state information report, wherein transmitting the first stage channel state information report is based at least in part on obtaining the first stage channel state information report.

3. The UE of claim 2, wherein, to generate the one or more first unit channel state information reports, the one or more processors are individually or collectively operable to execute the code to cause the UE to:
generate at least two first unit channel state information reports of the one or more first unit channel state information reports using an integer quantity of channel state information processing units of the UE.

4. The UE of claim 1, wherein each unit channel state information report of the one or more first unit channel state information reports indicates channel state information for respective pairs of information each comprising a candidate cell and a channel state information resource.

5. The UE of claim 1, wherein the one or more processors are individually or collectively further operable to execute the code to cause the UE to:
receive, from the network entity, a message indicating a list of respective pairs of information each comprising a candidate cell and a channel state information resource to be included in the first stage channel state information report, wherein the first stage channel state information report includes the one or more first unit channel state information reports based at least in part on receiving the message.

6. The UE of claim 5, wherein the one or more processors are individually or collectively further operable to execute the code to cause the UE to:
obtain a first channel state information measurement associated with a first pair of the list of respective pairs, wherein the first stage channel state information report excludes channel state information associated with the first pair based at least in part on the first channel state information measurement.

7. The UE of claim 1, wherein the first format is associated with reporting a wideband precoding matrix indicator and a rank indicator for each of the one or more first unit channel state information reports.

8. The UE of claim 1, wherein the first format is associated with reporting a rank indicator and a channel quality indicator for each of the one or more first unit channel state information reports.

9. The UE of claim 1, wherein the first format is associated with reporting a first part of a two-part channel state information associated with each of the one or more first unit channel state information reports.

10. The UE of claim 1, wherein the one or more processors are individually or collectively further operable to execute the code to cause the UE to:
quantize one or more channel state information parameters for each of the one or more first unit channel state information reports, wherein the first format is associated with reporting the quantized one or more channel state information parameters.

11. The UE of claim 1, wherein:
the first format is associated with reporting first channel state information for each of the one or more first unit channel state information reports; and
the second format is associated with reporting a difference for one or more parameters relative to corresponding ones of the first channel state information.

12. The UE of claim 1, wherein the first stage channel state information report is transmitted via an uplink control information message or via a media access control-control element, or any combination thereof.

13. The UE of claim 1, wherein each unit channel state information report of the one or more second unit channel state information reports indicates channel state information for respective pairs of information each comprising a candidate cell and a channel state information resource.

14. The UE of claim 1, wherein the one or more processors are individually or collectively further operable to execute the code to cause the UE to:
receive control information comprising a first configuration of the first stage channel state information report, wherein the first configuration comprises an indication to transmit the first stage channel state information report according to a first periodicity, semi-persistently, in response to reception of a first trigger, in response to an occurrence of one or more events, or any combination thereof.

15. The UE of claim 14, wherein the control information further comprises a second configuration of the second stage channel state information report, and wherein one or more parameters of the second configuration are the same as one or more parameters of the first configuration.

16. The UE of claim 15, wherein the one or more parameters of the second configuration are the same as the one or more parameters of the first configuration, and wherein:
the one or more second unit channel state information reports include one or more report quantities that are omitted from corresponding ones of the one or more first unit channel state information reports;
the second stage channel state information report is transmitted aperiodically or in accordance with a second periodicity; and
the first configuration or the second configuration, or both, indicates one or more time offset values between the first stage channel state information report and the second stage channel state information report.

17. The UE of claim 14, wherein the control information further comprises a second configuration of the second stage channel state information report, and wherein one or more parameters of the second configuration are different from one or more parameters of the first configuration.

18. The UE of claim 17, wherein the one or more parameters of the second configuration comprise a first reporting type that is different from a second reporting type indicated by the one or more parameters of the first configuration.

19. A method for wireless communications by a user equipment (UE), comprising:
receiving one or more reference signals that are associated with one or more candidate cells;
transmitting, to a network entity, a first stage channel state information report based at least in part on the one or more reference signals, wherein the first stage channel state information report comprises a first format for indicating one or more first unit channel state information reports associated with the one or more candidate cells and one or more channel state information resources; and
transmitting, after transmission of the first stage channel state information report, a second stage channel state information report based at least in part on the first stage channel state information report, wherein the second stage channel state information report comprises a second format for indicating one or more second unit channel state information reports associated with the one or more candidate cells and the one or more channel state information resources, the second format different from the first format.

20. A non-transitory computer-readable medium storing code for wireless communications, the code comprising instructions executable by at least one processor to:
receive one or more reference signals that are associated with one or more candidate cells;
transmit, to a network entity, a first stage channel state information report based at least in part on the one or more reference signals, wherein the first stage channel state information report comprises a first format for indicating one or more first unit channel state information reports associated with the one or more candidate cells and one or more channel state information resources; and
transmit, after transmission of the first stage channel state information report, a second stage channel state information report based at least in part on the first stage channel state information report, wherein the second stage channel state information report comprises a second format for indicating one or more second unit channel state information reports associated with the one or more candidate cells and the one or more channel state information resources, the second format different from the first format.
